(19) United States
(12) Patent Application Publication
(10) Pub. No.: US 2002/0031448 A1
(43) Pub. Date: Mar. 14, 2002

(54) Metal housing of an internal combustion engine exhaust gas senser having protective pipes

(76) Inventors: Helmut Weyl, Schwieberdingen (DE); Michael-Rainer Busch, Ebersbach (DE)

Correspondence Address: KENYON & KENYON, ONE BROADWAY, NEW YORK, NY, 10004, US

(21) Appl. No.: 09/935,985

(22) Filed: Aug. 23, 2001

(30) Foreign Application Priority Data
Aug. 23, 2000 (DE) 100 41 274.2

(51) Int. Cl. G01N 31/12

(52) U.S. Cl. 422/94

(57) ABSTRACT

An absolutely secure joining of the protective pipes to the housing is to be achieved during operation, in the case of a metal housing of an internal-combustion-engine exhaust gas sensor having two protective pipes attached thereto, the pipes being disposed coaxially one inside of the other and projecting outwardly from the housing; each of the pipes being made of the same kind of metal; at least the outer protective pipe being welded to the housing; and the pipes being radially set apart at least in their respective regions projecting from the housing. For this purpose, at least the inner pipe and the metal housing are joined to one another in a force-locked and form-locked manner in the axial direction of this protective pipe, via radially intermeshed projections, at least when the metal housing is in a closed state.

### FIELD OF THE INVENTION

The present invention relates to a metal housing of an internal combustion engine exhaust gas sensor having protective pipes.

### BACKGROUND INFORMATION

In the case of metal housings of this species known heretofore from practical use, the protective pipes are attached to the metal housing by flanging or welding.

In the case of these forms of attachment, high thermal and mechanical stresses can cause the connection between the protective pipes and the housing to detach, which can result in significant consequential damage. The generic attachment points of the protective pipes are subject to high stress since temperatures of over 750° in conjunction with accelerations of up to 1,300 m/s² in face velocities that can be higher than the sound velocity prevail.

### SUMMARY OF THE INVENTION

The connection between the protective pipes and the metal housing according to the present invention the advantage that a secure joining of the protective pipes to the housing is achieved simply, the joining being absolutely secure in practical use, even under unfavorable operating conditions. With regard to the connection types known heretofore, there is virtually no considerable increase in manufacturing costs, since only a one-time expenditure for tools for the production tool arises for the force-locked and form-locked connection of the present invention.

According to the present invention, at least the inner pipe is joined to the housing in the axial direction with force-locking and form-locking in an undercut manner, while it is not specified where on the housing this type of connection is provided, and whether the inner and outer protective pipes are attached to the housing in a shared region, in particular under coaxial contact.

According to the present invention, an advantageous connection of the inner protective pipe to the housing is shown, where both protective pipes are attached in different areas of the housing. In this design approach, the inner protective pipe reaches in an axial direction through an opening within the housing, the protective pipe being, in a sense, rigidly supported in the opening. As a result of the rigid bearing arrangement, a pipe supported in such a manner has a minimal tendency to flexurally vibrate, thereby inevitably increasing the stability of the connection of the pipe to the housing.

The inner protective pipe can be pushed through the housing into the bore of the bearing. The axial fixing is carried out in that, when the housing is sealed, the collar of the inner protective pipe, which is inside the housing and abuts on the housing, is pressed on an insert inserted into the housing.

According to the present invention, the collar, which is inside the housing, of an inner protective pipe supported in the housing bore can have a sealing function as a result of an appropriate construction. In this case, a sealing ring as a separate part that is otherwise necessary between an insert inside the housing and the outwardly leading housing opening is eliminated.

According to the present invention, in the case of the inner protective pipe being supported in the opening of the housing, the outer protective pipe can support itself at its free end, on the periphery of the inner protective pipe, via individual, inwardly projecting segments, which are integrally molded to this protective pipe. The inner protective pipe projects further than the outer protective pipe.

According to the present invention, the two protective pipes are coaxially supported one inside of the other, by a collar projecting outwardly from the housing. In this case, the inner protective pipe is clamped at the end present there to the housing collar in the axial direction, with force-locking and form-locking, in an undercut manner. Furthermore, both contiguous protective pipes are welded via an annular welded seam, which passes through both protective pipes, to the collar in a region of the housing collar that is situated axially adjacent to the annular clamping zone and runs out freely in the axial direction.

According to the present invention, a force-locking and form-locking connection of the inner protective pipe according to the present invention to an outwardly projecting collar of the metal housing is achieved in that provided in the collar is an annular groove into which segments, which are reshaped inwardly in the radial direction by the outer pipe, are pressed. In particular, such a connection can be a so-called crimp connection.

### BRIEF DESCRIPTION OF THE DRAWINGS

FIG. 1 shows a longitudinal cross section of a housing having protective pipes attached under coaxial contact.

FIG. 2 shows a longitudinal cross section of an alternative embodiment having a bearing arrangement of the inner protective pipe in an opening of the housing.

FIG. 3 shows a section of the protective pipe attachment, along line III-III in FIG. 1.

FIG. 4 shows an enlarged representation of a section of the protective pipe attachment, along line IV-IV in FIG. 3.

FIG. 5 shows a longitudinal cross section of a special embodiment of an outer protective pipe according to FIG. 2.

FIG. 6 shows a view of the outer protective pipe according to FIG. 5, in the direction of arrow VI.

### DETAILED DESCRIPTION

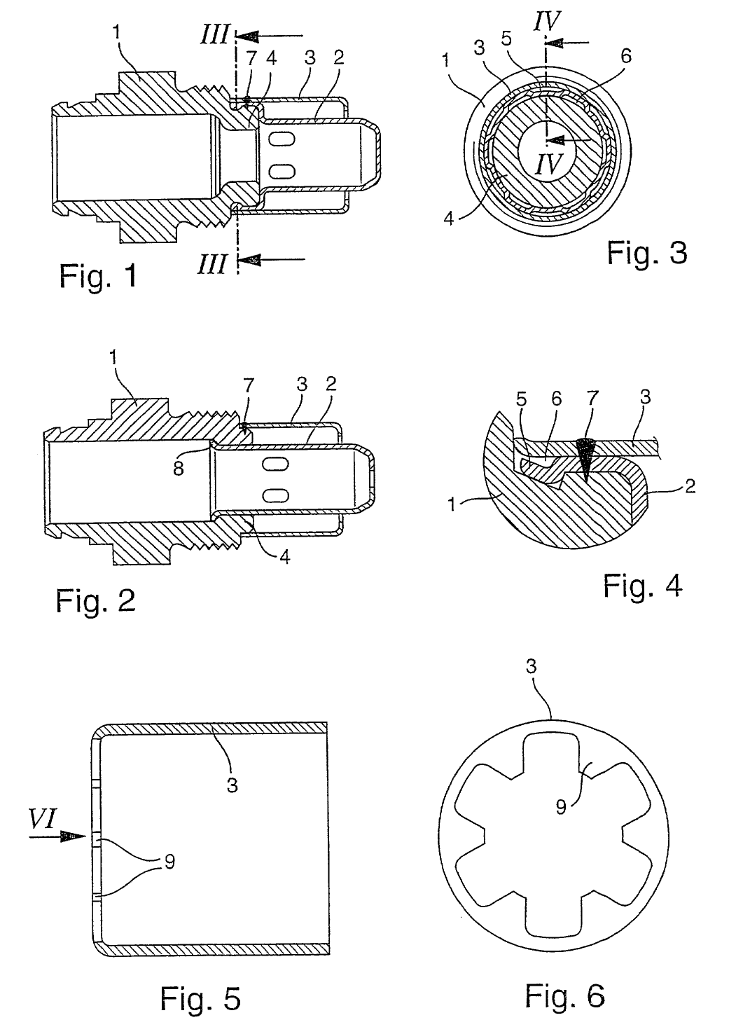

In the embodiment according to FIG. 1, there is a metal housing 1 of an emission gas sensor of an internal combustion engine, the housing being open on both sides in the axial direction, where an inner and an outer protective pipe 2 and 3, respectively, are attached to a collar 4, which projects outwardly from housing 1. Protective pipes 2 and 3 abut with mutual, radial contacting against housing collar 4. Inner protective pipe 2 is axially clamped to collar 4 in an undercut manner. In accordance with the representation in FIG. 3, this clamping consists of radial constrictions 5 being pressed in via the periphery of inner protective pipe 2, at the inner protective pipe's end area supported by collar 4, and specifically being pressed into an annular groove 6 within housing collar 4.

Together with inner protective pipe 2, outer protective pipe 3, which rests in the radial direction on inner protective pipe 2 in the region of collar 4, is fixed via an annular welded seam 7 to collar 4 of housing 1. In this context, annular welded seam 7 reaches through both protective pipes 2 and 3 while additionally engaging with collar 4.

Attaching inner protective pipe 2 to collar 4 of housing 1 by clamping in a force-locking and form-locking manner on the one side as well as welding on the other side results in a sufficiently secure attachment of both protective pipes 2 and 3 to housing 1.

In an alternative embodiment according to FIG. 2, only outer protective pipe 3 is attached via an annular welded seam 7 to an outwardly projecting collar 4 of housing 1.

Inner protective pipe 2 is supported here in an opening of housing 1. In this context, the end of inner protective pipe 2, which is inside housing 1, has an outwardly projecting collar 8. With the end face of collar 8, which faces away from the end of inner protective pipe 2, this collar abuts in a surface-locking manner against an annular surface of housing 1 formed in a complementary manner. In a sealed housing 1, an insert to be inserted into housing 1 is pressed on the opposite end face of collar 8. If there is such a pressing via an insert part, inner protective pipe 2 is securely fixed on all sides in the housing bore. As a result of the depth of the housing bore, inner protective pipe 2 has a relatively rigid bearing arrangement at housing 1.

Collar 8 of inner protective pipe 2, which is in the housing interior, can be coated with a soft metal, which is used as a seal. Thus, collar 8 can be used as a seal between housing 1 and the insert part (not shown) within the housing. As such, an otherwise customary sealing ring for this purpose is replaced.

Outer protective pipe 3, which is supported in housing 1 in the manner according to FIG. 2, can be provided at its end facing away from housing 1 with segments 9, which project inwardly in the radial direction (FIGS. 5, 6). Outer protective pipe 3 can be pressed via these segments 9 on inner protective pipe 2 to increase stability, segments 9 being able to be elastically shaped.

What is claimed is:

1. (New) An apparatus, comprising:
a metal housing of an internal combustion engine exhaust gas sensor;
two protective pipes made from a metal and being attached to the metal housing thereto, the two protective pipes being disposed coaxially one inside the other and projecting outwardly from the metal housing; and
radially intermeshed projections, wherein:
the two protective pipes include an outer protective pipe and an inner protective pipe,
at least the outer protective pipe is welded to the metal housing,
the two protective pipes are radially set apart at least in respective areas thereof projecting from the metal housing, and
at least the inner protective pipe and the metal housing are joined to one another in a force-locked and form-locked manner in an axial direction of the inner protective pipe via the radially intermeshed projections at least when the metal housing is in a closed state.

2. (New) The apparatus according to claim 1, wherein:
the inner protective pipe is axially supported in an opening of the metal housing,
the inner protective pipe projects into an inner free space of the metal housing,
an end area of the inner protective pipe that runs outwardly in a radial direction and is situated within the metal housing projects in as a collar beyond a cross section of a bearing opening of the metal housing, and
when the metal housing is in the closed state, a component inserted into the metal housing rests axially in a force-locked and surface-to-surface manner so as to have a fixing action against a housing-side, free end face of the collar.

3. (New) The apparatus according to claim 2, wherein:
when the metal housing is open, the inner free space of the metal housing runs freely out toward an outside of the metal housing at an end thereof opposite the opening supporting the inner protective pipe in the axial direction of the inner protective pipe, the inner free space having an overall diameter that surpasses an exterior diameter of the collar.

4. (New) The apparatus according to claim 2, wherein:
an area of the collar pointing axially into the inner free space includes a material acting as a seal.

5. (New) The apparatus according to claim 2, further comprising:
inwardly, radially running segments that are each set apart from one another over a periphery, wherein:
a free end of the outer protective pipe situated outside of the metal housing is pressed on the inner protective pipe via the inwardly, radially running segments.

6. (New) The apparatus according to claim 1, further comprising:
a collar projecting outwardly from the metal housing and supporting the inner protective pipe, wherein:
the outer protective pipe rests at the collar on the inner protective pipe, and
the two protective pipes and the metal housing are welded together via a radially continuous annular welded seam in a region situated axially between radial undercuts between the inner protective pipe and the collar, on the one side, and a freely running-out end of the collar, on the other side.

7. (New) The apparatus according to claim 6, wherein:
the radially intermeshed projections form, at the collar, an annular groove and, at the inner protective pipe, segments that are pressed into the annular groove and that are adjacent to one another over a periphery.
